(19) United States
(12) Patent Application Publication
(10) Pub. No.: US 2011/0053758 A1
(43) Pub. Date: Mar. 3, 2011

(54) REACTION TUBE AND HYDROTHERMAL PROCESSING FOR THE WET CHEMICAL CO-PRECIPITATION OF OXIDE POWDERS

(75) Inventors: Richard D. Weir, Cedar Park, TX (US); Carl W. Nelson, Cedar Park, TX (US)

(73) Assignee: EESTOR, INC., Cedar Park, TX (US)

(21) Appl. No.: 12/714,537

(22) Filed: Feb. 28, 2010

Related U.S. Application Data
(60) Provisional application No. 61/156,167, filed on Feb. 27, 2009.

(51) Int. Cl. C04B 35/00

(52) U.S. Cl. 501/134

(57) ABSTRACT

A reactor for the wet-chemical co-precipitation of oxide powders includes a cylindrical structure having first and second ends and a lumen extending the length of the tube. A central axis extends through the lumen. The first end is closed. The reactor also includes a first inlet port disposed proximal to the first end of the cylindrical structure and providing access through the cylindrical structure to inject a first reactant solution. The reactor further includes a second inlet port disposed proximal to the first end of the cylindrical structure and providing access through the cylindrical structure to inject a second reactant solution. The first and second inlet ports are disposed on opposite sides of the cylindrical structure and are coaxial relative to the central axis.

### CROSS REFERENCE TO CORRESPONDING APPLICATION

The present application claims priority from U.S. Provisional Patent Application No. 61/156,167, filed Feb. 27, 2009, entitled “REACTION TUBE AND HYDROTHERMAL PROCESSING FOR THE WET CHEMICAL CO-PRECIPITATION OF OXIDE POWDERS,” naming inventors Richard D. Weir and Carl W. Nelson, which application is incorporated by reference herein in its entirety.

### FIELD OF THE DISCLOSURE

This disclosure, in general, relates to apparatuses for the wet chemical co-precipitation of oxide powders, methods for using such apparatuses, hydrothermal post powder precipitation processes, and oxide powders resulting from such methods and processes.

### BACKGROUND

Within increasing interest in alternative energy sources, particularly in the case of alternatives to gasoline for use in motor vehicles, more and more reliance is being placed on sources of electricity. While methods of producing heat, light, and mechanical motion from electricity have significantly improved, methods for storing electricity have lagged behind. In particular, battery technologies are proving expensive and inefficient. Accordingly, there is a keen interest in methods for storing electricity, and research has turned to capacitive methods for storing electricity.

Conventional capacitive storage devices suffer from low energy density, low storage capacity, and high energy loss through leakage. Such properties are generally related to the nature of the dielectric layer of the conventional capacitive storage device. Low relative permittivity associated with conventional dielectric materials results in a low storage capacity for the conventional capacitive storage unit. In addition, such dielectric materials may suffer from high leakage rates and low breakdown voltages, further reducing the effectiveness of the capacitive storage unit.

Further, conventional dielectric materials used in forming some capacitive storage units are expensive. The material in aluminum electrolytic capacitors is expensive, has a high failure rate, and is bulky.

Advanced capacitor technology such as the double layer capacitor technology, being produced by Maxwell Technology also has serious problems, including low energy storage density and high cost. The low energy storage density of the Maxwell Technology technology is created by the low working voltage limits required by double layer capacitors. The energy storage of a capacitor is directly proportional to the square of the working voltage and since the upper limit of this technology is in the range of 2.5 V this limits energy density. The high cost of the double layer technology is created by the electrode material and the needed electronics to ensure that the capacitors do not exceed the working voltage if the capacitors are configured in a parallel of series configuration. If the working voltage of a double layer capacitor is exceeded, the dielectric layer is destroyed.

As a result, an improved dielectric material or particulate is desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary system for forming a dielectric particulate.

FIG. 2 and FIG. 3 include illustrations of an exemplary reactor.

FIG. 4 includes an illustration of an exemplary three-port reactor.

FIG. 5 includes an illustration of an exemplary x-ray diffraction.

FIG. 6 and FIG. 7 include illustrations of exemplary particle size distributions.

The use of the same reference symbols in different drawings indicates similar or identical items.

### DESCRIPTION OF THE DRAWINGS

In a particular embodiment, a system for forming dielectric particulate includes a reactor and a hydrothermal treatment apparatus. In an example, the reactor includes a cylindrical structure having an open end and a closed end and at least two injection ports disposed proximal to the closed end of the reactor. The at least two injection ports are positioned at approximately the same axial location relative to a central axis of the cylindrical tube and are positioned opposite each other, directing reactant solutions approximately directly at each other. In particular, the reactor has a turbulence intensity of at least 1.5×10⁷ cm/s³ at operating conditions. In addition, the system may include reactant storage vessels or pumps. The hydrothermal treatment apparatus is configured to hydrothermally treat reaction products at a temperature of at least 150° C. and a pressure of at least 100 psi.

In a further embodiment, a method of forming dielectric particulate includes injecting a first set of reactants into a first port of a reactor and injecting a second set of reactants into a second port of a reactor. The reactor includes a cylindrical structure or reaction tube having a closed end and an open end. The first and second ports are disposed proximal to the closed end of the reaction tube and are positioned coaxially and inject in opposite directions. In particular, the reactants are injected to provide a turbulence factor of at least 1.5×10⁷ cm/s³. The residence time of the reactor is at least 50 milliseconds. Following reactions within the reactor, the products are hydrothermally treated at a temperature of at least 150° C. and a pressure of at least 100 psi. The reactants include at least one metal nitrate, at least one metal chelate and at least one of tetraalkylammonium hydroxide or tetraalkylammonium oxalate.

In an additional embodiment, a dielectric particulate has a relative permittivity of at least 15,000, an average particle size of at least 0.7 μm and a half height ratio of not greater than 0.5. The half height ratio is the ratio of the width of the particle size distribution at half of the peak height to the average particle size. Further, the dielectric particulate may have an average particle size not greater than 2 μm. In particular, the dielectric particulate may include composition-modified barium titanate.

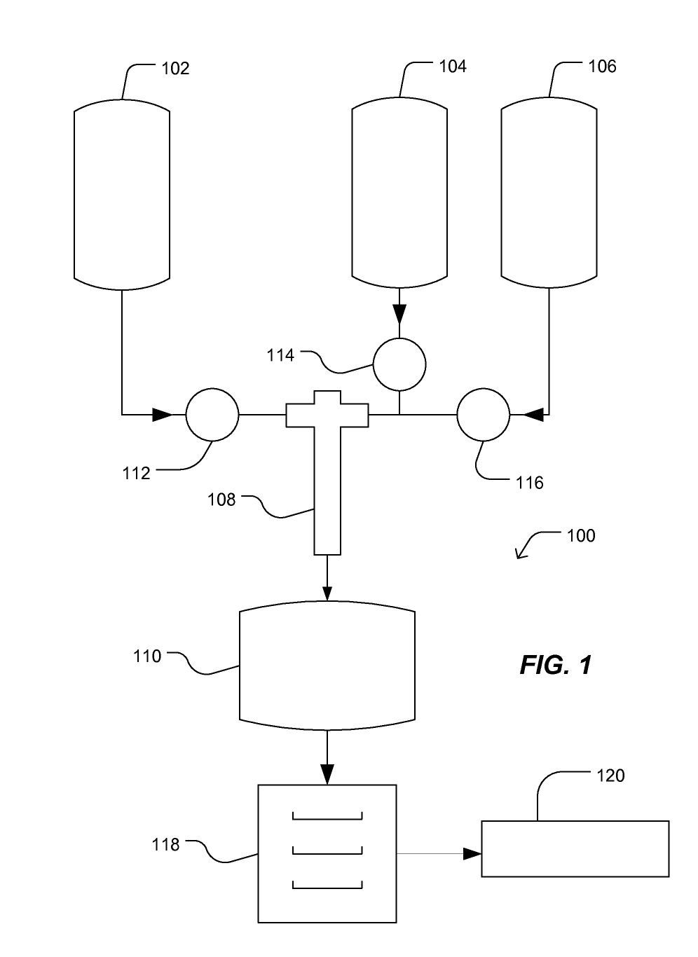

In an exemplary embodiment illustrated in FIG. 1, the system 100 for forming a dielectric particulate includes a reactor 108 and a hydrothermal treatment chamber 110. In addition, the system 100 may include reactant storage vessels 102, 104 or 106. Further, the system 100 may include pumps 112, 114 or 116. As illustrated, the pumps 112, 114 and 116 may pump reactant solutions from storage vessels 102, 104 or 106 into the reactor 108. Products from reactor 108 are directed to the hydrothermal treatment apparatus 110. Subsequently, the products of the hydrothermal treatment apparatus 110 are directed to a dryer 118, followed by decomposition and calcining equipment 120.

The reactant storage vessels 102, 104 or 106 include one or more reactants, for example, in the form of reactant solutions. In particular, the reactants may include a metal nitrate, a metal chelate, tetraalkylammonium hydroxide or tetraalkylammonium oxalate, or any combination thereof. The metal nitrate or metal chelate may include a metal ion or oxometal ion including a metal or semi-metal of groups 1-14 of the periodic table, the lanthanoid series, or the actinoid series, based on the IUPAC convention. For example, the metal ions may be selected from the group including barium, calcium, titanium, zirconium, yttrium, manganese, neodymium, tin, zinc, vanadium, niobium, tantalum, molybdenum, tungsten, lanthanum, hafnium, chromium, or any combination thereof. In particular, the metal ions include barium, titanium, and at least one of calcium, zirconium, yttrium, manganese, neodymium, tin, zinc, vanadium, niobium, tantalum, molybdenum, tungsten, lanthanum, hafnium, chromium, or any combination thereof. An exemplary metal nitrate includes barium nitrate, calcium nitrate, or a combination thereof. An exemplary metal chelate includes a metal ion or oxometal ion and a chelating agent. In an example, the chelating agent includes a carboxylic acid neutralized with a weak-base. For example, the chelating agent may include a neutralized alpha-hydroxycarboxylic acid. An exemplary alpha-hydroxycarboxylic acid includes 2-hydroxyethanoic acid (glycolic acid), 2-hydroxybutanedioic acid (malic acid), 2,3-dihydroxybutanedioic acid (tartaric acid), 2-hydroxy-1,2,3-propanetricarboxylic acid (citric acid), 2-hydroxybutanoic acid, 2-hydroxypentanoic acid, 2-hydroxyhexanoic acid, or any combination thereof. In a particular example, the alpha-hydroxycarboxylic acid includes citric acid. The chelating agent may be neutralized with a weak base, such as ammonium hydroxide (NH₄OH). The chelated solution may also include a surfactant.

Further, the reactants may include a tetraalkylammonium hydroxide, tetraalkylammonium oxalate or combinations thereof in which the alkyl group includes methyl, ethyl, or propyl groups or any combination thereof. In particular, the reactants may include a combination of tetramethylammonium hydroxide and tetramethylammonium oxalate.

As illustrated in FIG. 1, the reactants are pumped into the reactor 108 using pumps 112, 114, or 116. An alternative method of motivating the reactants into the reactor includes pressurizing the storage vessels 102, 104, or 106. In particular, the reactants are pumped through ports on the reactor that are coaxial and directly opposite, causing the reactant streams to directly impact one another.

The reactor 108 is configured to provide a turbulence intensity of at least 1.5×10⁷ cm/s³ at operating conditions. In an example, the operating conditions include a reaction tube velocity of at least 500 cm/s, such as at least 1000 cm/s, at least 1500 cm/s, or even at least 2000 cm/s. In a particular example, the reaction tube velocity is not greater than 20,000 cm/s, such as not greater than 15,000 cm/s, or even not greater than 10,000 cm/s. For example, the reactor 108 may include a reaction tube having a closed end and an open end. The injection ports may be disposed proximal to the closed end. Further, the ports are coaxial with and directly opposite one another. Once mixed, the reactants flow through the reactor 108 from the closed end towards the open end for a period of at least 50 milliseconds and are directed to a hydrothermal treatment chamber 110.

In the hydrothermal treatment chamber, the reactor 110 product streams are treated at a temperature of at least 150° C. and a pressure of least 100 psi for a period of at least 4 hours. For example, the temperature may be at least 175° C., such as at least 190° C. if the associated pressure is also increased. Further, the pressure may be at least 225 psi, such as at least 245 psi, or even at least 250 psi or higher. The hydrothermal treatment is performed for a period of at least 4 hours, such as at least 5 hours, or even at least 6 hours. In an example, the hydrothermal treatment is performed at a temperature in a range of 150° C. to 200° C. and a pressure in a range of 225 psi to 260 psi for a period in a range of 4 hours to 8 hours. Higher temperature and pressure combinations can be utilized if desired.

Following hydrothermal treatment, the resulting particulate material may be dried in a dryer 118. For example, the dielectric particulate material may be dried in a spray dryer, a pan dryer, a flash dryer, a cryogenic dryer, or any combination thereof. In a particular example, the dielectric particulate material is dried in a flash dryer. Prior to drying, the particulate material may be washed and partially separated. For example, the particulate material may be washed using deionized water and may be concentrated using a centrifuge. The washing and concentrating may be repeated one or more times.

Once dried, the particulate material may undergo decomposition and calcining For example, the particulate material may be heated at a temperature in a range of 25° C. to 1100° C. or higher. In particular, the material may be heated in an oxygenated and agitated environment to facilitate decomposition of organic byproducts and formation of a desired particulate material.

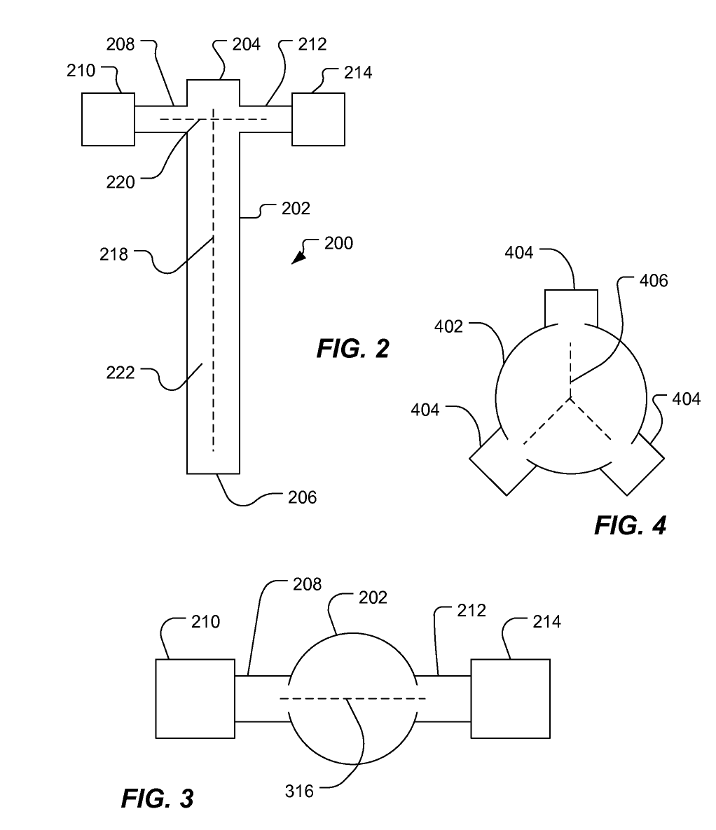

As stated above, the reactor is configured to perform the reaction at a turbulence intensity of at least 1.5×10⁷ cm/s³. In a particular embodiment, such high turbulence factor is achieved using a tubular reactor with coaxial and directly opposite injection. For example, a reactor 200 illustrated in FIG. 2 includes a cylindrical structure or tubular reactor 202 and injection ports 208 and 212. The tubular reactor 202 includes a closed end 204 and an open end 206 and a lumen 222 extending from the closed end 204 through the open end 206. In particular, the closed end 204 may be formed of a weld cap or screw cap. The injection ports 208 and 212 are disposed close to the closed end 204. Each of the injection ports 208 and 212 may include a connector 210 or 214 to which fluid conduits (not illustrated) carrying the reactant solutions are attached. Alternatively, the connector 210 or 214 may include a valve, such as a metering valve. For example, the metering valve may be a needle valve or metering valve available from Parker Instrumentation.

The injection ports 208 and 212 are disposed proximal to the closed end 204. In addition, the ports 208 and 212 are disposed at approximately the same axial location along an axis 218 of the tubular reactor 202. In a further example, the ports 208 and 212 are located within the same cross-sectional plane 220 perpendicular to the axis 218.

In addition, the ports 208 and 212 when viewed in the cross-section illustrated in FIG. 3 are positioned directly opposite one another. Within the plane 220, the ports 208 and 212 direct streams in an approximate line 316 directly toward one another. In particular, relative to port 208 within the plane 220, port 212 directs fluid in a direction approximately 180° opposite, such as within 10° of 180°, or within 5° of 180° or a lower angle of deviation. In alternative embodiments, the reactants may be injected through more than two ports. For example, the reactants may be injected into three or four ports. In such an example, at least two of the ports may be positioned coaxially and direct fluids in approximately opposite directions. Alternatively, the ports may be disposed within the same plane and may be positioned to direct fluids in evenly distributed directions. For example, in a three port configuration illustrated in FIG. 4, each port 404 may have approximately the same axial position along a reactor tube 402 (e.g., within the same plane), directing fluid in directions 406 that are 120° different from adjacent ports. In a four port configuration, the directions may be 90° different.

In an example, each of the ports has a Cv (according to the US measurement system) of not greater than 0.5, such as not greater than 0.1. In a particular example, the Cᵥ ratio, defined as the ratio of the Cv for the second stream divided by the Cv of the first stream is in a range of 1.0 and 0.1, such as in a range of 0.8 to 0.15, or even a range of 0.5 to 0.15. Further, the pressure drop when in use across ports 208 or 212 may be at least 20 psi, such as at least 40 psi, at least 60 psi, at least 80 psi, even at least 100 psi. In an example, the pressure drop is not greater than 500 psi.

The tubular part of the reactor 202 may be configured to provide both a desirable turbulence, as well as a desirable residence time for the reaction. For example, for a total flow rate on the order of 10 to 15 liters per minute, the inner diameter of the tubular reactor 202 may be in a range of 0.2 to 2 cm, such as a range of 0.3 cm to 1.5 cm, or even a range of 0.3 cm to 1.05 cm. In particular, the diameter may be greater than 0.3 cm and less than 1 cm. The length of the tubular reactor 202 may be at least 20 cm and may be not greater than 500 cm. In an example, the length is at least 40 cm, such as at least 70 cm, or even at least 100 cm. In particular, the length of the reactor may be in a range of 100 cm to 200 cm, such as a range of 125 cm to 200 cm, or even a range of 150 cm to 200 cm. While the diameter and length may be influenced by the flow rate, the ratio of the diameter to the length may be not greater than 0.1, such as not greater than 0.08, not greater than 0.05, or even not greater than 0.01. In particular, the ratio may be not greater than 0.005.

In an embodiment, the reactor 200 is configured to provide a high turbulence intensity, defined as the product of a dimensionless constant (k) characteristic of the mixing device (approximately 1.0 for the present reactor) and the cube of the velocity of the combined fluid streams in the mixer, divided by the square of the inside diameter of the mixer. For example, the turbulence intensity may be at least 1.5×10⁷ cm/s³, such as at least 10⁸ cm/s³, at least 10⁹ cm/s³, at least 10¹⁰ cm/s³, or even at least 5×10¹⁰ cm/s³. In general, the turbulence intensity is not greater than 10²⁰ cm/s³. In addition, the tubular reactor may provide an average Reynold's number of at least 20,000. For example, the Reynold's number may be at least 40,000, such as at least 60,000, at least 70,000, or even at least 75,000. In an example, the Reynolds number is not greater than 200,000.

The reactor may be configured for a residence time of at least 50 milliseconds, such as at least 70 milliseconds, or even at least 80 milliseconds. In an example, the reactor is configured for a residence time of not greater than 1 second.

In a particular embodiment, a method for forming dielectric particulate includes injecting reactant solutions into a tubular reactor. One of the reactant solutions may include metal ions in the form of nitrates or chelates. In particular, metal nitrates may include barium nitrate. In addition, the metal nitrates may include calcium nitrate. Further, the reactant solution may include a metal chelate including a metal or oxometal ion including titanium and at least one of zirconium, yttrium, manganese, neodymium, tin, zinc, vanadium, niobium, tantalum, molybdenum, tungsten, lanthanum, hafnium, chromium, or any combination thereof. In an example, the metal chelate is a stabilized metal chelate including an alpha-hydroxycarboxylic acid, such as citric acid, stabilized with ammonium hydroxide.

A second reactant solution may include tetraalkylammonium hydroxide, tetraalkylammonium oxalate, or a combination thereof. In a particular example, the second reactive solution includes a mixture of tetraalkylammonium hydroxide and tetraalkylammonium oxalate. The alkyl group of the tetraalkylammonium hydroxide or tetraalkylammonium oxalate may be a methyl, ethyl, or propyl group, or any combination thereof.

The reactant solutions are injected into the tubular reactor to provide both a desirable turbulence factor and other reaction conditions. In particular, the turbulence factor is at least 1.5×10⁷ cm/s³. The pH of the reaction may be in a range of 8 to 12, such as a range of 10 to 12. The temperature of the reactor may be in a range of 75° C. to 120° C., such as a range of 80° C. to 110° C., a range of 90° C. to 105° C., or even a range of 90° C. to 100° C. The pressure of the streams can be in the range of 90 psi to 120 psi or higher depending on the application. The residence time within the reactor may be at least 50 milliseconds.

In the tubular reactor, barium nitrate, titanium chelate, and other nitrate and chelate constituents coprecipitate to form a homogeneous particulate. Each particle within the homogeneous particulate has approximately the same composition, in contrast to a mixture of particles of different composition.

Following the reaction in the reactor, the resulting solution may be hydrothermally treated, for example in a pressure vessel. The temperature of the treatment may be at least 150° C. and the pressure may be at least 200 psi. For example, the temperature may be at least 180° C., such as at least 200° C. Further, the pressure may be at least 225 psi, such as at least 245 psi, at least 250 psi, or even at least 300 psi or higher. The hydrothermal treatment is performed for a period of at least 4 hours, such as at least 5 hours, or even at least 6 hours. In an example, the hydrothermal treatment is performed at a temperature in a range of 150° C. to 200° C. and a pressure in a range of 225 psi to 260 psi for a period in a range of 4 hours to 8 hours. In a particular example, the top of the hydrothermal treatment vessel may be cooled to facilitate reflux.

Following hydrothermal treatment, the resulting dielectric particulate may be washed and dried, such as through spray drying, pan drying, flash drying or other drying procedures. In particular, the particulate may be washed, concentrated, such as through centrifuging, and flash dried. The dried particulate may be subjected to heat treatment, such as decomposition and calcining, for example, in an oxygenated atmosphere, such as air and may be subjected to particle agitation.

In particular, the method exhibits desirable conversion of raw materials. In general, the metal ion components or reactants are expensive. The above method provides a desirably high percent conversion of the raw materials, particularly the metal ion components of reactants. For example, the above methods may provide a percent yield of at least 98%, such as at least 99%, or even at least 99.5%. Such desirable conversion reduces waste and contamination of downstream processes.

As a result of the process, a desirable dielectric particulate is provided. In particular, the dielectric particulate has a desirable particle size and particle size distribution. For example, the average (mean) particle size is at least 0.6 microns, such as at least 0.7 microns. In an example, the average particle size is in a range of 0.6 to 2 microns such as a range of 0.7 to 1.5 microns, a range of 0.9 to 1.5 microns, a range of 0.9 to 1.4 microns, or a range of 1.2 to 1.5 microns. Alternatively, the average particle size may be in a range of 0.6 to 1 microns, such as 0.6 to 0.9 microns, or even a range of 0.7 to 0.9 microns. In any case, the particle size distribution exhibits a half height ratio of not greater than 0.5. The half height ratio is defined as the ratio of the width of the particle size distribution at half of its maximum height and the average (mean) particle size. For example, the half height ratio may be not greater than 0.45, such as not greater than 0.4, not greater than 0.3, or even not greater than 0.2.

In a particular example, the dielectric particulate is a composition modified barium titanate particulate. In addition to barium titanate, the composition modified barium titanate particulate includes calcium and at least one of zirconium, yttrium, manganese, neodymium, tin, zinc, vanadium, niobium, tantalum, molybdenum, tungsten, lanthanum, hafnium, chromium, or any combination thereof. The dielectric particulate is a perovskite material, such as a cubic perovskite crystal structure, and has a relative permittivity of at least 15,000, such as at least 30,000.

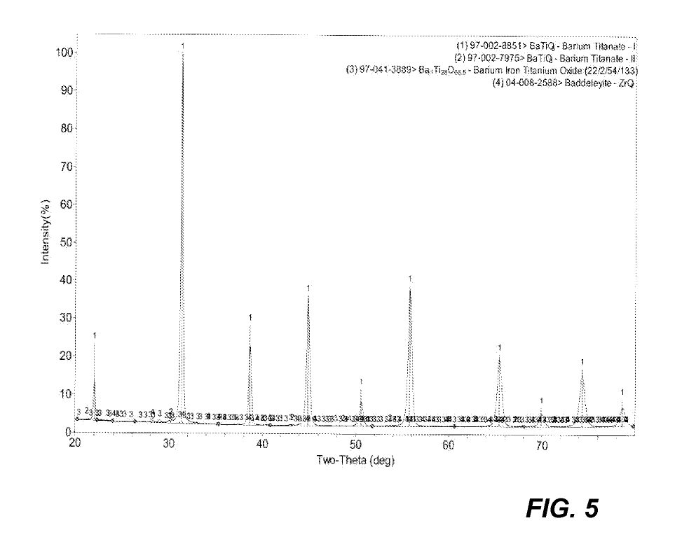

Yet another feature of the processing is indicated in FIG. 5, which includes an illustration of x-ray diffraction of the CMBT powder formed by a method described in Example 1, where the data indicates substantially uniform cubic perovskite crystal structure. The high peaks, the narrowness of the peaks indicate a substantially uniform crystalline structure and the quantitative data indicates a substantial homogeneity of the powder. Embodiments of the above-described production processes result in CMBT powders having the substantially uniform crystalline structure, as the x-ray diffraction data of FIG. 5 indicates. Also, the CMBT powder is substantially free of BaCO₃, indicating approximate elimination of activating chemical from the powders during the decomposition and calcining process to at least the parts per trillion level or lower. Further, the above analysis indicates that the CMBT powders have a high relativity permittivity. CMBT powders with high relative permittivity are useful in forming high energy storage capacitors that can provide high energy storage units.

Further, the dielectric particulate exhibits a desirable relative permittivity, such as at least 15,000, at least 17,500, at least 18,000, or even at least 20,000. In an example, the relative permittivity may be at least 30,000, such as at least 35,000.

In a particular embodiment, the dielectric particulate is a composition-modified barium titanate powder. The barium is at least partially substituted with calcium, neodymium, lanthanum, or a combination thereof, and the titanium is at least partially substituted with at least one of zirconium, yttrium, manganese, neodymium, tin, zinc, vanadium, niobium, tantalum, molybdenum, tungsten, hafnium, chromium, or any combination thereof. The composition modified barium titanate powder has an average particular size in a range of 0.6 to 1.5 micrometers, and a half width ratio of not greater than 0.5.

### Examples

The flow rate, Q_{L} (L/min), through a cylindrical chamber, such as a pipe or tube, can be expressed in terms of the velocity, V (cm/s), of the stream and the inside diameter, D (cm), of the cylindrical chamber as follows:

Q_{L}=0.04714 VD², or

V=21.22066(Q_{L}/D²)

Flow of a liquid through an orifice, taking into account the specific gravity of the fluid relative to pure water at 15° C. can be expressed in US liquid gallon units or ISO metric units as follows.

US Liquid Gallon System

Q_{L}=C_{V}(ΔP/SG)^{0.5}, wherein Q_{L} is the liquid flow rate in gallons (US liquid gallon) per minute, wherein C_{V} is the flow coefficient, which is the number of gallons of pure water at 15° C. that passes through a given orifice area, or passes through a given valve, in one minute, at a pressure drop of one psig, ΔP is the pressure drop across the orifice or valve in psig, and SG is the specific gravity of the liquid relative to pure water at 15° C.

ISO Metric System

Q_{L}=K_{V}(ΔP/SG)^{0.5}, wherein Q_{L} is the liquid flow rate in liters per minute, K_{V} the flow coefficient, which is the number of liters of pure water at 15° C. that passes through a given orifice area, or passes through a given valve, in one minute at a pressure drop of 1 bar gauge, ΔP is the pressure drop across the orifice or valve in bar gauge, and SG is the specific gravity of the liquid relative to pure water at 15° C.

Conversion Factor

1 K_{V}=14.4163 C_{V}

Using the US liquid gallon system, the flow rate, Q_{L}, can also be expressed as Q_{L}=C_{V}×K_{L}×K_{SG}, where Q_{L} and C_{V} are defined as above for the US liquid gallon system, K_{L}=(ΔP)^{0.5}, the square root of the pressure drop in psig across an orifice or valve, and K_{SG}=1/(SG)^{0.5}, the reciprocal of the square root of the specific gravity of the liquid.

### Example 1

A two-stream configuration as described in relation to FIG. 2 and FIG. 3 is prepared. The flow rate of stream 2 is one-fourth that of stream 1; the specific gravity of the stream 1 liquid is 1.20 and that of the stream 2 liquid is 1.016; and the (velocities) of stream 1, stream 2, and the combined stream are all equal.

Stream 1
C_{V1} for 0.125 inch (3.175 mm) diameter orifice: 0.300
SG specific gravity of first liquid: 1.20

K_{SG}=1/(1.20)^{0.5}=0.91287
ΔP pressure drop across orifice: 100 psig

K_{L}=(100 psig)^{0.5}=10

Then, Q_{L1}=(0.300)(0.91287)(10)=2.73861 gal/min (10.36678 L/min)

Stream 2

Q_{L2}=0.25 Q_{L1}=0.68465 gal/min (2.59169 L/min)
SG specific gravity of second liquid: 1.016

K_{SG}=1/(1.016)^{0.5}=0.99209
ΔP pressure drop across orifice: 100 psig

K_{L}=(100 psig)^{0.5}=10

Then C_{V}₂=Q_{L2}/(K_{L}×K_{SG})=0.069, and since C_{V2}/C_{V1}=Orifice Area 2/Orifice Area 1=(Orifice Diam. 2/Orifice Diam. 1)², then
0.069/0.300=(Orifice Diam. 2/0.125″)² and Orifice Diam. 2=0.060 inch

The combined stream flow rate in the reaction tube equals the sum of the flow rates of the two injected streams:

Q_{L}=Q_{L1}+Q_{L2}32 1.25, Q_{L1}=3.42327 gal/min (12.95847 L/min). The stream velocity V=Q_{L}/A, where A is the inside-tube cross-sectional area. In this example, the combined stream velocity is the same as that of the two injected streams, and thus, the inside-diameter reaction-tube area is equal to the sum of the two orifice areas of the injected streams: A_{RT}=A₁+A₂=0.0151 inch², and the resulting tube inside diameter is 0.139 inch. Accordingly, the stream velocity V=Q_{L1}/A1=Q_{L2}/A₂=(Q_{L1}+Q_{L2})/(A₁+A₂)=130,938.2249 cm/min=2182.3037 cm/s.

The turbulence intensity Tᵢ=kV³/D²=8.3794×10¹⁰ cm/s³. For an 80 ms residence time this tube must be 174.584 cm (5′ 8.734″) in length. Optionally, the reaction tube may be oriented vertically, or the reaction tube may be sloped slightly downward to collect the precipitated powder/liquid slurry in a vessel.

By determining the Reynolds number, the flow can be classified as laminar, transitional, or turbulent. The Reynolds number is dimensionless Re=(V×SG×D)/μ, where V is the stream velocity in mm/s, SG the specific gravity, D the inside tube diameter in mm, and μ the viscosity in mPa·s (1 mPa·s=1 cp). For this example, with SG=1.20, μ=1.20 mPa·s, and V and D as above but expressed in mm/s and mm, respectively, Re=76,856.7623, which is turbulent.

The first stream includes barium nitrate, organic titanium compound available under the tradename Tyzor® from DuPont™, and trace amounts of other metal nitrates and metal or oxometal citrates. The second stream includes a mixture of tetramethylammonium hydroxide and tetramethylammonium oxalate. The pH of the solution is maintained between 10 and 12 and the temperature is approximately 95° C. for both streams.

The particulate material formed in the reactor is hydrothermally treated using a pressure tank with a rating of 300 psi at 150° C. The tank top is chilled to condense water vapor, thereby ensuring the solution volume remains constant for the duration of the treatment. When the liquid stream including the particulate is delivered to the tank, the process parameters are set at 250 psi and 150° C. for a six-hour time. Tetramethylammonium hydroxide is added to maintain the pH in a range of 10 to 12.

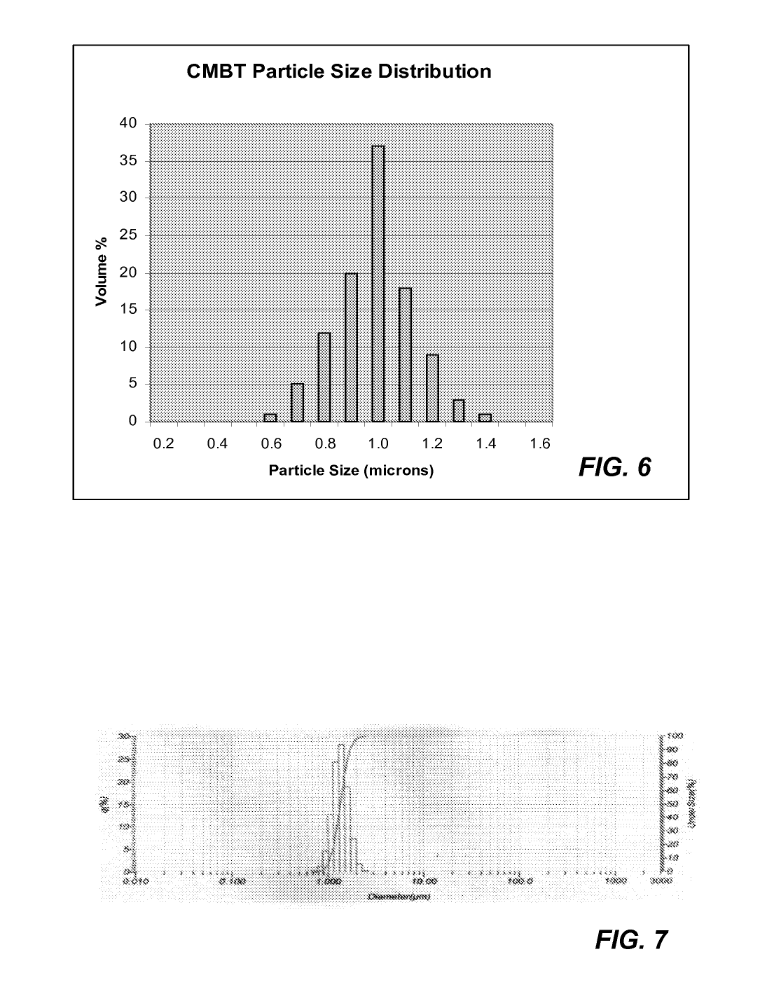

Following hydrothermal treatment, the particles are washed, concentrated in a centrifuge, flash dried, and subjected to decomposition and calcining at temperatures in a range of 25° C. to 1050° C. or higher. FIG. 6 illustrates the particle distribution. As illustrated, the mean particle size is approximately 0.92 μm and the half width ratio is less than 0.3.

### Example 2

Streams 1 and 2 are the same as in Example 1, but in Example 2 the reaction tube has an inside diameter of 1.000 cm (0.3937″). The combined flow rate remains the same, 12.95847 L/min (3.42327 gal/min), but the combined stream velocity V is lowered to (0.352182 cm/1.000 cm)² (2182.3037 cm/s)=270.6755 cm/s. The turbulence intensity is 1.98311×10⁷ cm/s³. For an 80 ms residence time, the tube is 21.654 cm (8.525″) in length. The Reynolds number (Re) equals 27,067.55, which is also turbulent.

The first stream includes barium nitrate, organic titanium compound available under the tradename Tyzor® from DuPont™, and trace amounts of other metal nitrates and metal or oxometal citrates, including metals selected from calcium, zirconium, yttrium, manganese, neodymium, tin, zinc, vanadium, niobium, tantalum, molybdenum, tungsten, lanthanum, hafnium, or chromium. The second stream includes a mixture of tetramethylammonium hydroxide and tetramethylammonium oxalate. The pH of the solution is maintained between 10 and 12 and the temperature is approximately 95° C.

The particulate material formed in the reactor is hydrothermally treated using a pressure tank with a rating of 300 psi at 150° C. The tank top is chilled to condense water vapor, thereby ensuring the solution volume remains constant for the duration of the treatment. When the liquid stream including the particulate is delivered to the tank, the process parameters are set at 250 psi and 150° C. for a six-hour time. The pH is maintained in a range of 10 to 12.

To determine percent yield, the composition of the aqueous starting precursors is verified. After the co-precipitation process is complete, the solid is removed and the remaining liquid is analyzed. The percentage of each constituent that has entered the composition modified barium titanate (CMBT) powder is determined. Analysis of the aqueous solutions is performed on a Perkin Elmer Optima 2100DV ICP-OES (induction-coupled-plasma optical-emission spectrograph). A calibration curve is generated for each analysis based on standards from High Purity Standards, Inc. At least eight standard solutions are used in calibration ranging from 0.0500 ppm to 10.0 ppm. The correlation coefficient of the calibration curves generated is greater than 0.999 for all constituents over the entire concentration range. Each calibration curve is manually inspected to insure there are no erroneous points influencing the linear correlation. The analysis and dilutions are performed in triplicate. Initial concentrations of the seven constituents are summarized in Table 1 and ranged from 30 to nearly 40,000 ppm. Analysis of the liquid after filtering out the CMBT powder shows constituent concentrations less than 10 ppm equating to nearly a 100% yield of each constituent in the CMBT powder.

TABLE 1
Liquid Analysis for Powder Preparation

| | Pre | Pre | Post | Post | Percent |
|---|---|---|---|---|---|
| | Process | Process | Process | Process | Yield |
| | (ppm) | (mg) | (ppm) | (mg) | (%) |
| Barium | 39133 | 290601 | 9.25 | 1690 | 99.42 |
| Tyzor ® | 11100 | 82428 | 0.107 | 2.24 | 100.00 |
| Comp #1 | 4200 | 31189 | 0.090 | 1.88 | 99.99 |
| Comp #2 | 56.06 | 416.3 | 0.091 | 1.90 | 99.54 |
| Comp #3 | 88.00 | 653.5 | <0.050 | 0.00 | 100.00 |
| Comp #4 | 30.00 | 222.8 | <0.050 | 0.00 | 100.00 |
| Comp #5 | 456.0 | 3386 | 0.386 | 8.07 | 99.76 |

Following hydrothermal treatment, the particles are washed, concentrated in a centrifuge, flash dried, and subjected to decomposition and calcining at temperatures in a range of 25° C. to 1050° C. or higher. FIG. 7 includes an illustration of an exemplary particle distribution. As illustrated, the mean particle size is approximately 1.38 μm and the half width ratio is less than 0.44. The relative permittivity is in the range of 18,000 to 50,000 over the temperature range of −20° C. to 65° C.

Table 2 illustrates the relationship of reaction tube inside diameter to stream velocity, turbulence intensity, and Reynolds number, and reaction tube length for a given total flow rate and residence time.

TABLE 2
Flow Characteristics for Reaction Tubes

| | | | | | Tube |
|---|---|---|---|---|---|
| | | | | | Length |
| Reaction | Liquid | | | | (80 ms |
| Tube | Flow | Stream | Turbulence | | residence |
| Diameter | Rate | Velocity | Intensity | Reynold's | time) |
| D | Q_{L} | V | Tᵢ | Number | L |
| Cm | L/min | Cm/s | cm/s³ | Re | Cm |
| 0.3175 | 10.367 | 2182 | 1.031 × 10¹¹ | 69,288 | 174.58 |
| 0.6350 | 10.367 | 545.6 | 4.02.7 × 10⁸ | 34,644 | 43.65 |
| 1.270 | 10.367 | 136.4 | 1.573 × 10⁶ | 17,322 | 10.91 |
| 2.540 | 10.367 | 34.10 | 6145 | 8661 | 2.728 |
| 5.080 | 10.367 | 8.525 | 24 | 4331 | 0.682 |
| 10.160 | 10.367 | 2.131 | 0.096 | 2165 | 0.170 |

Orifice diameter D: 0.125″ (3.175 mm)
US gal/min flow coefficient Cᵥ: 0.300
ISOV L/min flow coefficient Kᵥ: 4.325
Conversion factor: one Kᵥ = 14.4163 Cᵥ
Pressure drop ΔP across orifice: 100 psig (6.8948 barg)
Specific gravity SG relative to pure water at 4° C. of one g/cm³: 1.20
Viscosity μ relative to pure water at 20° C. of one mPa · s = one cp: 1.20

Reaction Tube Design Examples

### Design Example 1

From readily available Type 316 stainless steel tubing with 0.375″ OD and 0.065″ wall, a reaction tube is fabricated. One tubing end is closed by TIG welding a cap onto the tubing. Near the closed end two oppositely placed holes, one of 0.125″ diameter and the other of 0.060″ diameter, are drilled. At each orifice and centered with the orifice, a one-inch length of 0.250″ OD Type 316 stainless steel tubing at a 90° angle is TIG welded onto the 0.375″OD tubing. To each of the one-inch lengths, a Parker UltraSeal Socket-Weld Face-Seal Connector Fitting, 0.250″ OD tube size (Part No. 4-4 QHW), is TIG welded. The open end of the 0.375″ OD tubing may be provided with a Parker UltraSeal Socket-Weld Face-Seal Connector Fitting, 0.375″ OD tube size (Part No. 6-6 QHW or Part No. 8-6 QHW) for its connection by Type 316 stainless steel tubing, polypropylene plastic tubing or tubing of other plastics and elastomers to the vessel in which the powder precipitate and liquid are collected and further treated. For the same total flow rate described in Examples 1 and 2, the reaction-tube inside diameter of 0.245″ (0.6223 cm) results in a stream velocity V=698.9553 cm/s; a turbulence intensity T=8.818×10⁸ cm/s³; and a Reynolds number (Re) of 43,496. An 80 ms residence time results in a reaction tube of 55.916 cm (22.014″) length. A 100 ms residence time results in a 70 cm (27.6″) length.

### Design Example 2

An alternative design includes the use of metering valves, which provide adjustable ranges of orifice flow coefficients. From a graph showing the flow coefficient C_{V} vs. the amount of turns open for a metering valve (or needle valve), the desired C_{V} can be set. The Parker Instrumentation product line of metering valves, or other similar metering valves, provide wide-open-valve flow coefficients C_{V} in the N Series of 0.039, 0.042, 0.055, 0.057, 0.207, and 0.299, and in the HR Series of 0.0004, 0.0070, 0.0140, 0.0200, 0.0210, 0.0300, 0.0320, 0.0470, 0.0490, 0.1180, and 0.1550, this latter series being unique among metering valves in featuring shut-off capability. Needle valves with regulating stems can be used for applications requiring higher wide-open-valve flow coefficients. The Parker Instrumentation product line of needle valves provides wide-open-valve flow coefficients C_{V} in the NP6 Series of 0.60 and 0.67, and in the V Series of 0.12, 0.28, 0.37, 0.43, 0.55, 0.97, and 1.05.

Stainless steel tubing with 0.250″ OD and a 0.035″ wall-thickness can accommodate flow coefficients C_{V} up through 0.43; with 0.375″ OD and a 0.065″ wall-thickness, a C_{V} of 0.55 can be used; and with 0.500″ OD and a 0.083″ wall-thickness, the C_{V} of 0.97 and 1.05 can be used. Instead of drilling two oppositely placed holes as orifices in the Type 316 stainless steel tubing with 0.375″ OD and 0.065″ wall thickness in Design Example 1, two holes of 0.250″ diameter are drilled for TIG welding on each a one-inch length of Type 316 stainless steel tubing with 0.250″ OD and 0.028″ or 0.035″ wall thickness. To each of these one-inch length tubes, a Parker UltraSeal Socket-Weld Face-Seal Connector Fitting, 0.250″ OD tube size (Part No. 4-4 QHW) is TIG welded, which provides a highly reliable and durable readily assembled/disassembled connection for any of the above-described metering and needle valves with wide-open-valve flow coefficients not exceeding the flow coefficient of this connecting tubing.

In a first aspect, a method of forming a dielectric particulate includes contacting first and second process streams at a turbulence intensity of at least 1.5×107 cm/s³. The first process steam includes tetraalkylammonium hydroxide or tetraalkylammonium oxalate. The second process stream includes a metal ion nitrate and a metal ion chelate, the metal ion nitrate and the metal ion chelate coprecipitating in the presence of the tetraalkylammonium hydroxide or the tetraalkylammonium oxalate to form a particulate material. The method further includes hydrothermally treating the particulate material.

In an example of the first aspect, the turbulence intensity is at least 10⁸ cm/s³, such as at least 10⁹ cm/s³, at least 10¹⁰ cm/s³, or even at least 5.0×10¹⁰ cm/s³.

In a further example of the first aspect, the metal ion nitrate includes barium nitrate. In an additional example, the second process stream further includes calcium nitrate. In another example, the metal chelate includes a chelate of titanium. In an example, the second process stream further includes a metal ion chelate including a metal or oxometal ion selected from the group consisting of zirconium, yttrium, manganese, neodymium, tin, zinc, vanadium, niobium, tantalum, molybdenum, tungsten, hafnium, chromium, and any combination thereof. In particular, the metal chelate includes a neutralized alpha-hydroxycarboxylic acid chelating agent. The alpha-hydroxycarboxylic acid chelating agent can be selected from the group consisting of 2-hydroxyethanoic acid (glycolic acid), 2-hydroxybutanedioic acid (malic acid), 2,3-dihydroxybutanedioic acid (tartaric acid), 2-hydroxy-1,2,3-propanetricarboxylic acid (citric acid), 2-hydroxybutanoic acid, 2-hydroxypentanoic acid, and 2-hydroxyhexanoic acid. In particular, the alpha-hydroxycarboxylic acid chelating agent includes citric acid.

In another example, the first process stream including the tetraalkylammonium hydroxide and the tetraalkylammonium oxalate.

In an additional example, the method further includes drying the particulate material. In another example, the method further includes heat treating the dried particulate material to form the dielectric particulate having a cubic perovskite structure.

In a second aspect, a method of forming a dielectric particulate includes contacting first and second process streams at a turbulence intensity of at least 1.5×10⁷ cm/s³. The first process steam includes tetraalkylammonium hydroxide or tetraalkylammonium oxalate. The second process stream includes a metal ion nitrate and a metal ion chelate. The metal ion nitrate and the metal ion chelate coprecipitates in the presence of the tetraalkylammonium hydroxide or the tetraalkylammonium oxalate to form a particulate material. The method further includes hydrothermally treating the particulate material, drying the hydrothermally treated particulate material, and heat treating the dried particulate material to form the dielectric particulate material having a cubic perovskite structure.

In an example of the second aspect, the turbulence intensity is at least 10⁸ cm/s³. The metal ion nitrate includes barium nitrate. In another example, the second process stream includes calcium nitrate. In a further example, the metal chelate includes a chelate of titanium. In an additional example, the second process stream further includes a metal ion chelate including a metal or oxometal ion selected from the group consisting of zirconium, yttrium, manganese, neodymium, tin, zinc, vanadium, niobium, tantalum, molybdenum, tungsten, hafnium, chromium, and any combination thereof. In another example, the metal chelate includes a neutralized alpha-hydroxycarboxylic acid chelating agent. In an example, the alpha-hydroxycarboxylic acid chelating agent is selected from the group consisting of 2-hydroxyethanoic acid (glycolic acid), 2-hydroxybutanedioic acid (malic acid), 2,3-dihydroxybutanedioic acid (tartaric acid), 2-hydroxy-1,2,3-propanetricarboxylic acid (citric acid), 2-hydroxybutanoic acid, 2-hydroxypentanoic acid, and 2-hydroxyhexanoic acid. In a further example, the alpha-hydroxycarboxylic acid chelating agent include citric acid.

In another example of the second aspect, the first process stream includes the tetraalkylammonium hydroxide and the tetraalkylammonium oxalate.

In a third aspect, a method of forming a dielectric particulate includes contacting first and second process streams at a turbulence intensity of at least 10⁸ cm/s³. The first process steam includes tetraalkylammonium hydroxide and tetraalkylammonium oxalate. The second process stream includes a barium nitrate, calcium nitrate, a titanium chelate, and at least one metal chelate including a metal or oxometal ion selected from the group consisting of zirconium, yttrium, manganese, neodymium, tin, zinc, vanadium, niobium, tantalum, molybdenum, tungsten, hafnium, chromium, and any combination thereof. The chelate of metal chelate is an alpha-hydroxycarboxylic acid chelating agent selected from the group consisting of 2-hydroxyethanoic acid, 2-hydroxybutanedioic acid, 2,3-dihydroxybutanedioic acid, 2-hydroxy-1,2,3-propanetricarboxylic acid, 2-hydroxybutanoic acid, 2-hydroxypentanoic acid, and 2-hydroxyhexanoic acid. The barium nitrate, calcium nitrate, titanium chelate and the at least one metal chelate coprecipitate in the presence of the tetraalkylammonium hydroxide and the tetraalkylammonium oxalate to form a homogenous particulate material. The method further includes hydrothermally treating the homogenous particulate material, drying the hydrothermally treated homogenous particulate material, and heat treating the dried homogenous particulate material to form the dielectric particulate material having a cubic perovskite structure.

In a fourth aspect, a reactor for the wet-chemical co-precipitation of oxide powders includes a cylindrical structure having first and second ends and a lumen extending the length of the tube. A central axis extends through the lumen. The first end is closed. The reactor further includes a first inlet port disposed proximal to the first end of the cylindrical structure and provides access through the cylindrical structure to inject a first reactant solution. The reactor also includes a second inlet port disposed proximal to the first end of the cylindrical structure and providing access through the cylindrical structure to inject a second reactant solution, the first and second inlet ports disposed on opposite sides of the cylindrical structure and positioned at approximately the same axial location relative to the central axis.

In an example of the fourth aspect, the reactor has a turbulence intensity of at least 1.5×10⁷ cm/s³ under process conditions, such as at least 10⁸ cm/s³ under process conditions, at least at least 10⁹ cm/s³ under process conditions, or even at least 10¹⁰ cm/s³ under process conditions.

In a further example of the fourth aspect, the cylindrical structure has in inner diameter and a length, a ratio of the inner diameter to the length being not greater than 0.08, such as not greater than 0.05, or not greater than 0.01. In an example, the first inlet port has a Cᵥ of not greater than 0.5.

In an additional example, the Reynold's number of fluid flowing through the cylindrical structure is at least 20,000 at process conditions, such as at least 40,000 or even at least 60,000. The pressure drop across the first inlet port can be at least 20 psi at process conditions, such as at least 60 psi.

In a fifth aspect, a system for preparing dielectric particulate includes a first process stream including tetraalkylammonium hydroxide or tetraalkylammonium oxalate, a second process stream including at least one metal nitrate and at least one metal chelate, a reactor, and a hydrothermal treatment apparatus connected to a second end of the reactor. The reactor includes a cylindrical structure having first and second ends and a lumen extending the length of the tube. A central axis extends through the lumen. The first end is closed. The reactor further includes a first inlet port connected to first process stream and disposed proximal to the first end of the cylindrical structure. The first inlet provides access through the cylindrical structure to inject the first process stream. The reactor also includes a second inlet port connected to the second process stream and disposed proximal to the first end of the cylindrical structure. The second inlet port provides access through the cylindrical structure to inject the second process stream. The first and second inlet ports are disposed on opposite sides of the cylindrical structure and are positioned at approximately the same axial location relative to the central axis.

In a sixth aspect, a method of preparing an oxide powder includes injecting a first reactant solution into a first inlet port of a reactor. The reactor includes a cylindrical structure having first and second ends and a lumen extending the length of the tube. A central axis extends through the lumen. The first end is closed. The reactor further includes the first inlet port disposed proximal to the first end of the cylindrical structure and provides access through the cylindrical structure. The reactor further includes a second inlet port disposed proximal to the first end of the cylindrical structure and provides access through the cylindrical structure. The first and second inlet ports are disposed on opposite sides of the cylindrical structure and are positioned at approximately the same axial location relative to the central axis. The method further includes injecting a second reactant solution into the second inlet port of the reactor simultaneously with injecting the first reactant solution to form a process solution. The process solution has a turbulence intensity of at least 1.5×10⁷ cm/s³ and reacts to form particulate material. The method also includes collecting the particulate material. In an example of the sixth aspect, the method further includes hydrothermally treating the particulate material.

In a seventh aspect, a particulate material includes composition modified barium titanate particles including a barium titanate perovskite material. The barium is substituted with less than 10 wt % calcium. The titanium substituted with less than 2 wt % of at least one metal ion selected from the group consisting of zirconium, yttrium, manganese, neodymium, tin, zinc, vanadium, niobium, tantalum, molybdenum, tungsten, hafnium, chromium, and any combination thereof. The composition modified barium titanate particles have an average particles size in a range of 0.6 microns to 2.0 microns and have a half-width ratio of not greater than 0.5.

In an example of the seventh aspect, the half-width ratio is not greater than 0.45, such as not greater than 0.4, or even not greater than 0.3. The average particle size is in a range of 0.7 microns to 1.5 microns, such as a range of 0.9 microns to 1.5 microns, or even a range of 0.6 microns to 0.9 microns.

In a further example of the seventh aspect, the particulate material has a relative permittivity of at least 15,000, such as at least 17,500, or even at least 18,000.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A method of forming a dielectric particulate, the method comprising:
contacting first and second process streams at a turbulence intensity of at least 1.5×10⁷ cm/s³, the first process steam including tetraalkylammonium hydroxide or tetraalkylammonium oxalate, the second process stream including a metal ion nitrate and a metal ion chelate, the metal ion nitrate and the metal ion chelate coprecipitating in the presence of the tetraalkylammonium hydroxide or the tetraalkylammonium oxalate to form a particulate material; and
hydrothermally treating the particulate material.

2. The method of claim 1, wherein the turbulence intensity is at least 10⁸ cm/s³.

3. The method of claim 2, wherein the turbulence intensity is at least 10⁹ cm/s³.

4.-5. (canceled)

6. The method of claim 1, wherein the metal ion nitrate includes barium nitrate.

7. The method of claim 6, further comprising calcium nitrate.

8. The method of claim 1, wherein the metal chelate includes a chelate of titanium.

9. The method of claim 8, further comprising a metal ion chelate including a metal or oxometal ion selected from the group consisting of zirconium, yttrium, manganese, neodymium, tin, zinc, vanadium, niobium, tantalum, molybdenum, tungsten, hafnium, chromium, and any combination thereof.

10. The method of claim 1, wherein the metal chelate includes a neutralized alpha-hydroxycarboxylic acid chelating agent.

11. The method of claim 10, wherein the alpha-hydroxycarboxylic acid chelating agent is selected from the group consisting of 2-hydroxyethanoic acid (glycolic acid), 2-hydroxybutanedioic acid (malic acid), 2,3-dihydroxybutanedioic acid (tartaric acid), 2-hydroxy-1,2,3-propanetricarboxylic acid (citric acid), 2-hydroxybutanoic acid, 2-hydroxypentanoic acid, and 2-hydroxyhexanoic acid.

12. The method of claim 11, wherein the alpha-hydroxycarboxylic acid chelating agent include citric acid.

13. The method of claim 1, wherein the first process stream including the tetraalkylammonium hydroxide and the tetraalkylammonium oxalate.

14. The method of claim 1, further comprising drying the particulate material.

15. The method of claim 1, further comprising heat treating the dried particulate material to form the dielectric particulate having a cubic perovskite structure.

16. A method of forming a dielectric particulate, the method comprising:
contacting first and second process streams at a turbulence intensity of at least 1.5×10⁷ cm/s³, the first process steam including tetraalkylammonium hydroxide or tetraalkylammonium oxalate, the second process stream including a metal ion nitrate and a metal ion chelate, the metal ion nitrate and the metal ion chelate coprecipitating in the presence of the tetraalkylammonium hydroxide or the tetraalkylammonium oxalate to form a particulate material;
hydrothermally treating the particulate material;
drying the hydrothermally treated particulate material; and
heat treating the dried particulate material to form the dielectric particulate material having a cubic perovskite structure.

17. The method of claim 16, wherein the turbulence intensity is at least 10⁸ cm/s³.

18. The method of claim 16, wherein the metal ion nitrate includes barium nitrate.

19. The method of claim 18, further comprising calcium nitrate.

20. The method of claim 16, wherein the metal chelate includes a chelate of titanium.

21. The method of claim 20, further comprising a metal ion chelate including a metal or oxometal ion selected from the group consisting of zirconium, yttrium, manganese, neodymium, tin, zinc, vanadium, niobium, tantalum, molybdenum, tungsten, hafnium, chromium, and any combination thereof.

22. The method of claim 16, wherein the metal chelate includes a neutralized alpha-hydroxycarboxylic acid chelating agent.

23.-25. (canceled)

26. A method of forming a dielectric particulate, the method comprising:
contacting first and second process streams at a turbulence intensity of at least 10⁸ cm/s³, the first process steam including tetraalkylammonium hydroxide and tetraalkylammonium oxalate, the second process stream including a barium nitrate, calcium nitrate, a titanium chelate, and at least one metal chelate including a metal or oxometal ion selected from the group consisting of zirconium, yttrium, manganese, neodymium, tin, zinc, vanadium, niobium, tantalum, molybdenum, tungsten, hafnium, chromium, and any combination thereof, the chelate of metal chelate being an alpha-hydroxycarboxylic acid chelating agent selected from the group consisting of 2-hydroxyethanoic acid, 2-hydroxybutanedioic acid, 2,3-dihydroxybutanedioic acid, 2-hydroxy-1,2,3-propanetricarboxylic acid, 2-hydroxybutanoic acid, 2-hydroxypentanoic acid, and 2-hydroxyhexanoic acid, the barium nitrate, calcium nitrate, titanium chelate and the at least one metal chelate coprecipitating in the presence of the tetraalkylammonium hydroxide and the tetraalkylammonium oxalate to form a homogenous particulate material;
hydrothermally treating the homogenous particulate material;
drying the hydrothermally treated homogenous particulate material; and
heat treating the dried homogenous particulate material to form the dielectric particulate material having a cubic perovskite structure.

27.-53. (canceled)
